(19) United States
(12) Patent Application Publication
(10) Pub. No.: US 2007/0132928 A1
(43) Pub. Date: Jun. 14, 2007

(54) Liquid crystal display having biaxial compensating film

(75) Inventors: I-An Yao, Miao-Li (TW); Hung-Lin Ko, Miao-Li (TW); Chueh-Ju Chen, Miao-Li (TW); Chiu-Lien Yang, Miao-Li (TW); Jin-Jei Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/636,734

(22) Filed: Dec. 11, 2006

(30) Foreign Application Priority Data
Dec. 9, 2005 (TW) 94143563

(51) Int. Cl. G02F 1/1335

(52) U.S. Cl. 349/118

(57) ABSTRACT

An exemplary liquid crystal display (200) includes a first polarizer (211), a first biaxial compensating film (213), a first discotic liquid crystal film (214), a first substrate (215), a liquid crystal layer (220), a second substrate (235), a second discotic liquid crystal film (234), and a second polarizer (231), arranged in that order from one side of the liquid crystal display to an opposite side of the liquid crystal display. In summary, the first biaxial compensating film can compensate light in two perpendicular directions, thus improving contrast ratios in the two directions of the liquid crystal display and broadening a view angle of the liquid crystal display. Therefore, the liquid crystal display has an improved display performance.

### FIELD OF THE INVENTION

The present invention relates to liquid crystal displays (LCDs), and particularly to a liquid crystal display having a biaxial compensating film.

### GENERAL BACKGROUND

A typical liquid crystal display is capable of displaying a clear and sharp image through thousands or even millions of pixels that make up the complete image. The liquid crystal display has thus been applied to various electronic equipment in which messages or pictures need to be displayed, such as mobile phones and notebook computers. However, liquid crystal in the liquid crystal display does not itself emit light. Rather, the liquid crystal has to be lit up by a light source so as to clearly and sharply display text and images. The light source may be ambient light, or a backlight module attached to the liquid crystal display.

Referring to FIG. 4, a typical liquid crystal display 100 includes a liquid crystal panel 102 and a backlight module 104. The backlight module 104 is located adjacent to the liquid crystal panel 102, and provides a planar light source for the liquid crystal panel 102.

The liquid crystal panel 102 includes a first substrate assembly 110, a second substrate assembly 130 opposite to the first substrate assembly 110, and a liquid crystal layer 120 sandwiched between the first and second substrate assemblies 110, 130. The liquid crystal layer 120 includes a plurality of positive liquid crystal molecules (Δn>0).

The first substrate assembly 110 includes a first polarizer 111, a first quarter-wave plate 113, a first discotic liquid crystal film 114, a first substrate 115, a common electrode 117, and a first alignment layer 119, disposed in that order from top to bottom. The second substrate assembly 130 includes a second alignment layer 139, a pixel electrode 137, a second substrate 135, a second discotic liquid crystal film 134, a second quarter-wave plate 133, and a second polarizer 131, disposed in that order from top to bottom.

A slow axis of the first quarter-wave plate 113 is perpendicular to a slow axis of the second quarter-wave plate 133. An absorption axis of the first polarizer 111 is perpendicular to an absorption axis of the second polarizer 131. An angle of the slow axis of the first quarter-wave plate 113 relative to the absorption axis of the first polarizer 111 is 45 degrees. An angle of the slow axis of the second quarter-wave plate 133 relative to the absorption axis of the second polarizer 131 is 45 degrees.

In general, the quarter-wave plates 113, 133 are uniaxial compensating films. Such films only can compensate light in a predetermined direction, and cannot compensate light in a direction perpendicular to the predetermined direction. Thus the liquid crystal display 100 is apt to have a low contrast ratio in the direction perpendicular to the predetermined direction, and have a narrow viewing angle. That is, the display performance of the liquid crystal display 100 may be unsatisfactory.

Therefore, a new liquid crystal display that can overcome the above-described problems is desired.

### SUMMARY

In one preferred embodiment, a liquid crystal display includes a first polarizer, a first biaxial compensating film, a first discotic liquid crystal film, a first substrate, a liquid crystal layer, a second substrate, a second discotic liquid crystal film, and a second polarizer, arranged in that order from one side of the liquid crystal display to an opposite side of the liquid crystal display.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of a liquid crystal display according to a first embodiment of the present invention.

FIG. 2 is a side cross-sectional view of a liquid crystal display according to a second embodiment of the present invention.

FIG. 3 is a side cross-sectional view of a liquid crystal display according to a third embodiment of the present invention.

FIG. 4 is a side cross-sectional view of a conventional liquid crystal display.

### DETAILED DESCRIPTION OF PREFERRED EMBODIMENTS

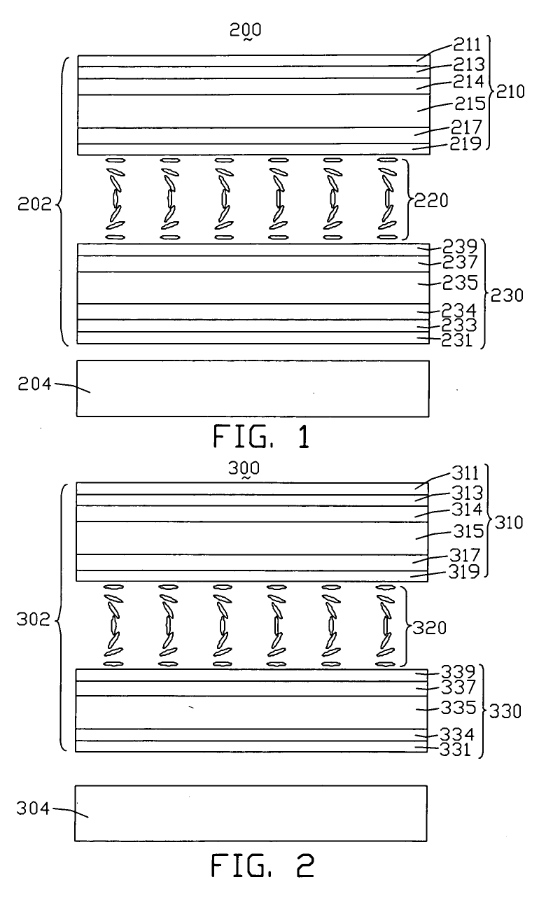

Referring to FIG. 1, a liquid crystal display 200 according to a first embodiment of the present invention is shown. The liquid crystal display 200 includes a liquid crystal panel 202 and a backlight module 204. The backlight module 204 is located adjacent to the liquid crystal panel 202, and provides a planar light source for the liquid crystal panel 202.

The liquid crystal panel 202 includes a first substrate assembly 210, a second substrate assembly 230 opposite to the first substrate assembly 210, and a liquid crystal layer sandwiched between the first and second substrate assemblies 210, 230.

The first substrate assembly 210 includes a first polarizer 211, a first biaxial compensating film 213, a first discotic liquid crystal film 214, a first substrate 215, a common electrode 217, and a first alignment layer 219, disposed in that order from top to bottom. The second substrate assembly 230 includes a second alignment layer 239, a pixel electrode 237, a second substrate 235, a second discotic liquid crystal film 234, a second biaxial compensating film 233, and a second polarizer 231, disposed in that order from top to bottom.

The liquid crystal layer 220 includes a plurality of positive liquid crystal molecules. The liquid crystal layer 220 satisfies the following equations: K₃₃/K₁₁=1.26, K₂₂=5.6pN (pN=10⁻¹²N), Δnd₁=760 nm, wherein K₁₁ represents a coefficient of elasticity in compression of the liquid crystal molecules, K₂₂ represents a coefficient of elasticity in torsion of the liquid crystal molecules, K₃₃ represents a coefficient of elasticity in flexion of the liquid crystal molecules, Δn represents a complex refractive index of the liquid crystal layer 220, and d₁ represents a thickness of the liquid crystal layer 220. A working voltage of the liquid crystal layer 220 is in the range from 1.5˜7 volts.

The first and second biaxial compensating films 213, 233 have a same thickness and a same refractive index, and satisfy the following equations: (nₓ−n_{y})d₂=145.2 nm, (nₓ−n_{z})d₂=390.73 nm, wherein d₂ represents a thickness of the first biaxial compensating film 213, nₓ represents a refractive index in an X-axis of the first biaxial compensating film 213, n_{y} represents a refractive index in a Y-axis of the first biaxial compensating film 213, and n_{z} represents a refractive index in a Z-axis of the first biaxial compensating film 213.

The first and second discotic liquid crystal films 214, 234 each have a hybrid structure, and each includes a plurality of negative liquid crystal molecules (Δn<0). The first and second discotic liquid crystal films 214, 234 have a same thickness and a same refractive index, and satisfy the following equation: ((Nₓ+N_{y})/2−N_{z})d₃=60 nm, wherein d₃ represents a thickness of the first discotic liquid crystal film 214, nₓ represents a refractive index in an X-axis of the first discotic liquid crystal film 214, n_{y} represents a refractive index in a Y-axis of the first discotic liquid crystal film 214, and n_{z} represents a refractive index in a Z-axis of the first discotic liquid crystal film 214. An average pretilt angle of the first discotic liquid crystal film 214 is equal to an average pretilt angle of the second discotic liquid crystal film 234. Preferably, the average pretilt angle is approximately 35.5 degrees.

The common electrode 217 and the pixel electrode 237 can be made from a transparent conductive material, such as indium tin oxide (ITO) or indium zinc oxide (IZO). The first and second substrates 215, 235 can be made from a transparent material, such as glass or quartz.

Pretilt angles of the first and second alignment layers 219, 239 are in the range from 0˜15 degrees. The first and second alignment layers 219, 239 both have horizontal alignment characteristics. An alignment direction of the first alignment layer 219 is parallel to an alignment direction of the second alignment layer 239.

An angle of an absorption axis of the first polarizer 211 relative to the alignment direction of the first alignment layer 219 is 45 degrees. An absorption axis of the second polarizer 231 is perpendicular to the absorption axis of the first polarizer 211. A slow axis of the first biaxial compensating film 213 is parallel to a slow axis of the second biaxial compensating film 233, and is parallel to the absorption axis of the second polarizer 231.

In summary, the first and second biaxial compensating films 213, 233 can compensate light in two perpendicular directions, thus improving contrast ratios in the two directions of the liquid crystal display 200 and broadening a viewing angle of the liquid crystal display 200. Therefore, the liquid crystal display 200 has improved display performance.

Referring to FIG. 2, a liquid crystal display 300 according to a second embodiment of the present invention is shown. The liquid crystal display 300 includes a liquid crystal panel 302 and a backlight module 304. The backlight module 304 is located adjacent to the liquid crystal panel 302, and provides a planar light source for the liquid crystal panel 302.

The liquid crystal panel 302 includes a first substrate assembly 310, a second substrate assembly 330 opposite to the first substrate assembly 310, and a liquid crystal layer 320 sandwiched between the first and second substrate assemblies 310, 330.

The first substrate assembly 310 includes a first polarizer 311, a biaxial compensating film 313, a first discotic liquid crystal film 314, a first substrate 315, a common electrode 317, and a first alignment layer 319, disposed in that order from top to bottom. The second substrate assembly 330 includes a second alignment layer 339, a pixel electrode 337, a second substrate 335, a second discotic liquid crystal film 334, and a second polarizer 331, disposed in that order from top to bottom. The liquid crystal layer 320 includes a plurality of positive liquid crystal molecules.

The first and second discotic liquid crystal films 314, 334 each have a hybrid structure, and each includes a plurality of negative liquid crystal molecules. The common electrode 317 and the pixel electrode 337 can be made from a transparent conductive material, such as ITO or IZO. The first and second substrates 315, 335 can be made from a transparent material, such as glass or quartz.

Pretilt angles of the first and second alignment layers 319, 339 are in the range from 0˜15 degrees. The first and second alignment layers 319, 339 both have horizontal alignment characteristics. An alignment direction of the first alignment layer 319 is parallel to an alignment direction of the second alignment layer 339.

An angle of an absorption axis of the first polarizer 311 relative to the alignment direction of the first alignment layer 319 is 45 degrees. An absorption axis of the second polarizer 331 is perpendicular to the absorption axis of the first polarizer 311, and is parallel to a slow axis of the biaxial compensating film 313.

In summary, the biaxial compensating film 313 can compensate light in two perpendicular directions, thus improving contrast ratios in the two directions of the liquid crystal display 300 and broadening a viewing angle of the liquid crystal display 300. Therefore, the liquid crystal display 300 has improved display performance.

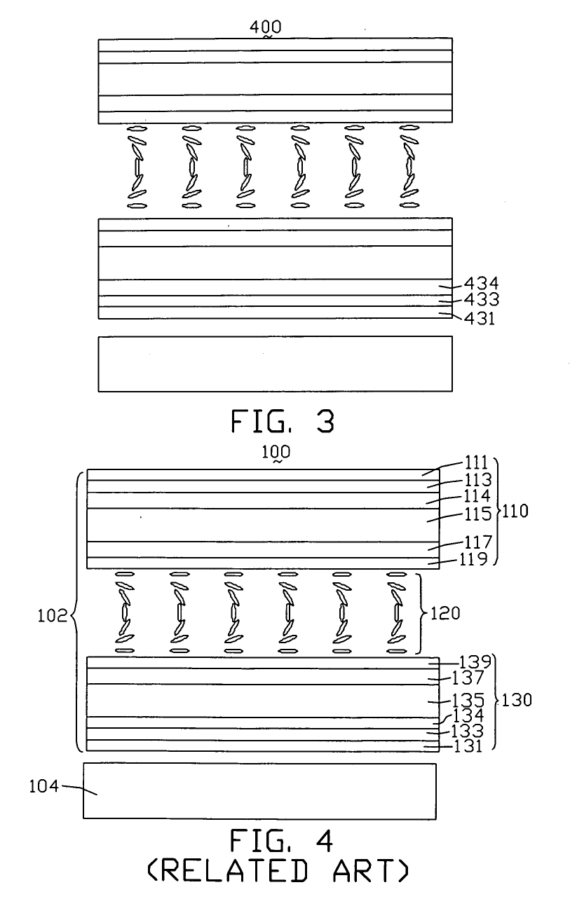

Referring to FIG. 3, a liquid crystal display 400 according to a third embodiment of the present invention is similar to the liquid crystal display 300 of the second embodiment. However, in a first substrate assembly (not labeled) of the liquid crystal display 400, there is no biaxial compensating film. Instead, a biaxial compensating film 433 is disposed between a second polarizer 431 and a second discotic liquid crystal film 434 of a second substrate assembly (not labeled) of the liquid crystal display 400.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display comprising a first polarizer, a first biaxial compensating film, a first discotic liquid crystal film, a first substrate, a liquid crystal layer, a second substrate, a second discotic liquid crystal film, and a second polarizer, arranged in that order from one side of the liquid crystal display to an opposite side of the liquid crystal display.

2. The liquid crystal display as claimed in claim 1, wherein the liquid crystal layer comprises a plurality of positive liquid crystal molecules, and the first biaxial compensating film comprises a plurality of negative liquid crystal molecules.

3. The liquid crystal display as claimed in claim 1, further comprising a first alignment layer between the first substrate and the liquid crystal layer, and a second alignment layer between the second substrate and the liquid crystal layer.

4. The liquid crystal display as claimed in claim 3, wherein a pretilt angle of each of the first and second alignment layers is in the range from 0˜15 degrees, and an alignment direction of the first alignment layer is parallel to an alignment direction of the second alignment layer.

5. The liquid crystal display as claimed in claim 4, wherein an absorption axis of the first polarizer is perpendicular to an absorption axis of the second polarizer.

6. The liquid crystal display as claimed in claim 5, wherein an angle of the absorption axis of the first polarizer relative to the alignment direction of the first alignment layer is approximately 45 degrees.

7. The liquid crystal display as claimed in claim 6, wherein a slow axis of the first biaxial compensating film is parallel to the absorption axis of the second polarizer.

8. The liquid crystal display as claimed in claim 7, further comprising a second biaxial compensating film between the second discotic liquid crystal film and the second polarizer, wherein a slow axis of the second biaxial compensating film is parallel to the slow axis of the first biaxial compensating film.

9. The liquid crystal display as claimed in claim 8, wherein the liquid crystal layer comprises a plurality of liquid crystal molecules, and satisfies the follow equations: K₃₃/K₁₁=1.26, K₂₂=5.6pN, wherein K₁₁ represents a coefficient of elasticity in compression of the liquid crystal molecules, K₂₂ represents a coefficient of elasticity in torsion of the liquid crystal molecules, and K₃₃ represents a coefficient of elasticity in flexion of the liquid crystal molecules.

10. The liquid crystal display as claimed in claim 8, wherein the liquid crystal layer satisfies the following equation: Δnd₁=760 nm, wherein Δn represents a complex refractive index of the liquid crystal layer, and d₁ represents a thickness of the liquid crystal layer.

11. The liquid crystal display as claimed in claim 8, wherein a working voltage of the liquid crystal layer is in the range from approximately 1.5 to approximately 7 volts.

12. The liquid crystal display as claimed in claim 8, wherein the first and second biaxial compensating films have a same thickness and a same refractive index, and satisfy the following equation: (nₓ−n_{y})d₂=145.2 nm, wherein d₂ represents a thickness of the first biaxial compensating film, nₓ represents a refractive index in an X-axis of the first biaxial compensating film, and n_{y} represents a refractive index in a Y-axis of the first biaxial compensating film.

13. The liquid crystal display as claimed in claim 12, wherein the first and second biaxial compensating films further satisfy the following equation: (nₓ−n_{z})d₂=390.73 nm, wherein n_{z} represents a refractive index in a Z-axis of the first biaxial compensating film.

14. The liquid crystal display as claimed in claim 8, wherein the first and second discotic liquid crystal films have a same thickness and a same refractive index, and satisfy the following equation: ((Nₓ+N_{y})/2−N_{z})d₃=60 nm, wherein d₃ represents a thickness of the first discotic liquid crystal film, nₓ represents a refractive index in an X-axis of the first discotic liquid crystal film, n_{y} represents a refractive index in a Y-axis of the first discotic liquid crystal film, and n_{z} represents a refractive index in a Z-axis of the first discotic liquid crystal film.

15. The liquid crystal display as claimed in claim 8, wherein an average pretilt angle of the first discotic liquid crystal film is equal to an average pretilt angle of the second discotic liquid crystal film, which is approximately 35.5 degrees.

16. The liquid crystal display as claimed in claim 3, further comprising a common electrode between the first substrate and the first alignment layer, and a pixel electrode between the second substrate and the second alignment layer.

17. The liquid crystal display as claimed in claim 16, wherein each of the common and pixel electrodes is made from material selected from the group consisting of indium tin oxide and indium zinc oxide.

18. The liquid crystal display as claimed in claim 1, wherein each of the first and second substrates is made from material selected from the group consisting of glass or quartz.

19. A liquid crystal display comprising a first polarizer, a first discotic liquid crystal film, a first substrate, a liquid crystal layer, a second substrate, a second discotic liquid crystal film, a biaxial compensating film, and a second polarizer, arranged in that order from one side of the liquid crystal display to an opposite side of the liquid crystal display.

20. A liquid crystal display comprising a liquid crystal layer, a first polarizer and a second polarizer respectively located by two sides of the liquid crystal layer, said first polarizer further equipped with a biaxial compensating film facing the liquid crystal layer, wherein an absorption axis of the first polarizer is perpendicular to an absorption axis of the first polarizer but is parallel to a slow axis of the biaxial compensating film.
